(19) United States
(12) Patent Application Publication
(10) Pub. No.: US 2025/0348768 A1
(43) Pub. Date: Nov. 13, 2025

(54) THRESHOLD ESTIMATION METHOD AND ELECTRONIC DEVICE

(71) Applicant: ASUSTeK COMPUTER INC., Taipei (TW)

(72) Inventors: Tai-I CHEN, Taipei (TW); Sheng-Hung HUNG, Taipei (TW)

(21) Appl. No.: 19/176,526

(22) Filed: Apr. 11, 2025

(30) Foreign Application Priority Data
May 10, 2024 (TW) 113117480

(51) Int. Cl. G06N 7/01; G06F 17/18

(52) U.S. Cl. CPC G06N 7/01; G06F 17/18

(57) ABSTRACT

A threshold estimation method and an electronic device are provided. The electronic device includes a processing device and a storage device. Negative sample data is stored in the storage device. The processing device is electrically connected to the storage device and performs threshold estimation. The threshold estimation method includes: reading negative sample data, and extracting feature values; compressing the feature values into training data; calculating and recording anomaly scores of the training data to obtain an anomaly score distribution chart, the anomaly score distribution chart including a local extreme value and a global extreme value; estimating a probability distribution model corresponding to the anomaly score distribution chart based on the local extreme value and the global extreme value; calculating a confident interval based on the probability distribution model; and obtaining a threshold with meaning of negative sample probability distribution based on an upper limit value of the confident interval.

### CROSS-REFERENCE TO RELATED APPLICATION

This application claims the priority benefit of Taiwan Application Serial No. 113117480, filed on May 10, 2024. The entirety of the above-mentioned patent application is hereby incorporated by reference herein and made a part of specification.

### BACKGROUND OF THE INVENTION

### Field of the Invention

The disclosure relates to a threshold estimation method applied to unsupervised defect detection and an electronic device performing a threshold estimation method.

### Description of the Related Art

In the training process of an unsupervised defect detection artificial intelligence model, since no positive sample containing defects is added, no effective manner is provided to estimation a threshold for distinguishing between the positive sample and a negative sample during inference, and a user needs to adjust the threshold based on the samples inferred online.

A common practice is to require the user to provide one or more sets of data containing positive samples, and determine the threshold based on an anomaly score of the positive samples. However, this manner easily causes many false negative determinations due to sampling bias in the selected positive samples, and the threshold has no meaning in probability statistics, and changes with a quantity and types of positive samples provided by the users. Another practice is to artificially generate defects, and perform model prediction, to obtain a probability distribution of the anomaly scores of the positive samples through repeated sampling a plurality of times. However, the probability distribution is based on the artificially generated defects, which is usually not representative of a probability distribution of real defects and consumes extra computing power and time.

### BRIEF SUMMARY OF THE INVENTION

The disclosure provides a threshold estimation method, including: reading a plurality of pieces of negative sample data, and extracting a plurality of feature values; compressing the feature values into a plurality of pieces of training data; calculating and recording a plurality of anomaly scores of the training data to obtain an anomaly score distribution chart, the anomaly score distribution chart including a local extreme value and a global extreme value; estimating a probability distribution model corresponding to the anomaly score distribution chart based on the local extreme value and the global extreme value; calculating a confident interval based on the probability distribution model; and obtaining a threshold with meaning of negative sample probability distribution based on an upper limit value of the confident interval.

The disclosure further provides an electronic device, including a storage device and a processing device. The storage device stores a plurality of pieces of negative sample data. The processing device is electrically connected to the storage device. The processing device is configured to: read the negative sample data, extract a plurality of feature values, compress the feature values into a plurality of pieces of training data, and calculate and record a plurality of anomaly scores of the training data to obtain an anomaly score distribution chart. The anomaly score distribution chart includes a local extreme value and a global extreme value. The processing device is configured to: estimate a probability distribution model corresponding to the anomaly score distribution chart based on the local extreme value and the global extreme value; calculate a confident interval based on the probability distribution model; and obtain a threshold with meaning of negative sample probability distribution based on an upper limit value of the confident interval.

Based on the above, the disclosure provides a threshold estimation method and an electronic device. In a training process of an unsupervised defect detection artificial intelligence model, a threshold is effectively estimated through the negative sample data, to propose a consistency standard based on the probability distribution. In addition, the threshold and the probability distribution obtained through a probability distribution model trained with probabilistic anomaly scores of negative samples directly represent results of model prediction. Therefore, the disclosure does not need extra computing power and time for estimation of the artificial intelligence model, and the calculation is completed at the same time when the unsupervised model training process is completed.

### BRIEF DESCRIPTION OF THE DRAWINGS

FIG. 1 is a schematic block diagram of an electronic device according to an embodiment of the disclosure.

FIG. 2 is a schematic flowchart of a threshold estimation method performed by an electronic device according to an embodiment of the disclosure.

FIG. 3 is a curve diagram of a cumulative probability distribution function generated by an electronic device according to an embodiment of the disclosure.

FIG. 4 is a schematic flowchart of a threshold estimation method performed by an electronic device according to another embodiment of the disclosure.

### DETAILED DESCRIPTION OF THE EMBODIMENTS

Preferred embodiments are provided below for detailed description. However, the embodiments are merely used as examples for description, and do not limit the protection scope of the disclosure. In addition, some elements are omitted in the drawings in the embodiments, to clearly show the technical features of the disclosure. Same reference numerals are used to indicate the same or similar elements in all of the drawings.

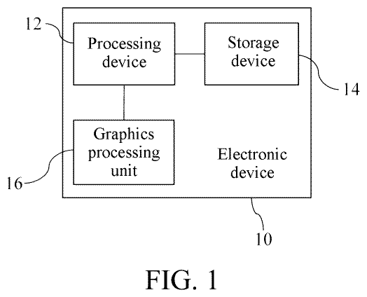

Referring to FIG. 1, an electronic device 10 includes a processing device 12 and a storage device 14. The processing device 12 is electrically connected to the storage device 14. A plurality of pieces of negative sample data is stored in the storage device 14. The processing device 12 reads the negative sample data from the storage device 14, and directly estimates a threshold based on the negative sample data. Furthermore, the electronic device 10 further includes a graphics processing unit 16. The graphics processing unit 16 is electrically connected to the processing device 12. When the processing device 12 performs operation or training, the graphics processing unit 16 assists the processing device 12 in performing related operation, so as to assist the operation and accelerate the overall operation speed through the graphics processing unit 16. In an embodiment, the electronic device 10 is a device such as a personal computer, a notebook computer, a tablet computer that independently performs artificial intelligence training operation. However, the disclosure is not limited thereto.

In an embodiment, the processing device 12 is a central processing unit (CPU), another general-purpose or special-purpose microprocessor, a microcontroller, a micro control unit (MCU), a digital signal processor (DSP), a programmable controller, an application specific integrated circuit (ASIC), another similar element, or any combination of the foregoing elements. However, the disclosure is not limited thereto.

In an embodiment, the storage device 14 is any type of fixed or removable random access memory (RAM), a read-only memory (ROM), a flash memory, a hard disk drive (HDD), a solid state drive (SSD), another similar element, or any combination of the foregoing elements, which is configured to store any model, parameter data, or the like required by the processing device 12. However, the disclosure is not limited thereto.

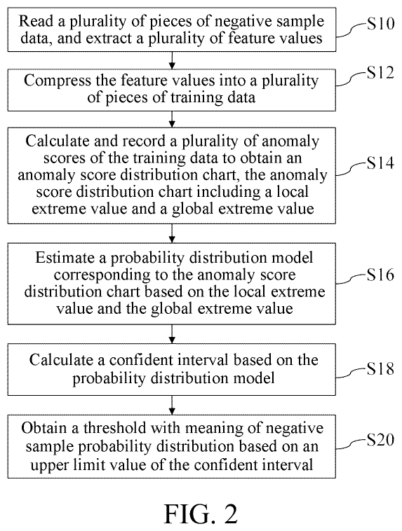

In the electronic device 10, the processing device 12 performs the threshold estimation method through software. Referring to FIG. 1 and FIG. 2 together, as shown in step S10, the processing device 12 reads a plurality of pieces of negative sample data from the storage device 14, and extracts a plurality of feature values from the negative sample data through a deep learning model. As shown in step S12, the processing device 12 performs compression processing on the feature values, to compress the feature values into a plurality of pieces of training data in a dimension reduction manner. As shown in step S14, the processing device 12 calculates and records a plurality of anomaly scores of the compressed training data through a defect detection algorithm (please help confirm whether) to obtain an anomaly score distribution chart. The anomaly score distribution chart includes a local extreme value and a global extreme value. In an embodiment, the anomaly scores are stored in the storage device 14, which is not limited thereto. In an embodiment, the defect detection algorithm has different anomaly score calculation methods based on different algorithms, such as a patch distribution modeling (PaDiM) which calculates an anomaly score through a pixel-wise Mahalanobis distance. However, the disclosure is not limited thereto, and is applicable to any calculation method for the anomaly score.

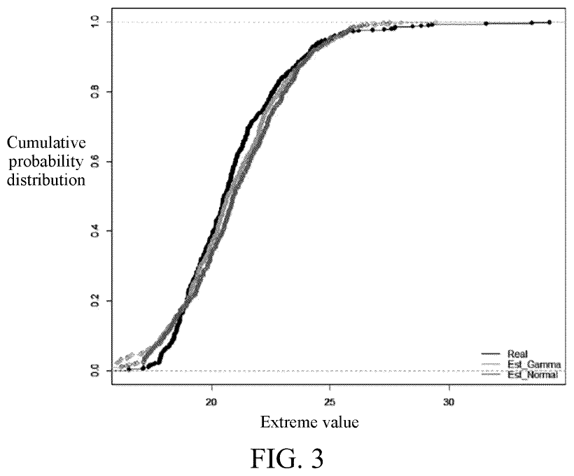

As shown in step S16, the processing device 12 estimates a probability distribution model corresponding to the anomaly score distribution chart based on the local extreme value and the global extreme value. The probability distribution model is a thick tail probability model. In an embodiment, the local extreme value is an unbiased estimator of the global extreme value. Through the unsupervised defect detection algorithm, an anomaly score distribution chart (also referred to as a defect score distribution chart or a defect score heat map) with the same resolution as the original force is usually predicted in the end. In the disclosure, an area of ¼ of the original size is randomly selected from the anomaly score distribution chart, and an extreme value of the anomaly scores is used as the local extreme value. The anomaly score distribution chart is repeatedly sampled 10 times, and the local extreme value is recorded. Then kernel density estimation (KDE) is performed on an extreme value distribution of the local extreme value and the global extreme value through Gaussian distribution and Gamma distribution respectively, so as to perform curve fitting. In a cumulative probability distribution function (cumulative density function, CDF) shown in FIG. 3, an X axis in the figure is the extreme value of anomaly scores of negative samples, and a Y axis is a cumulative probability distribution, Real represents a real extreme value distribution, Est_Gamma is an extreme value-cumulative probability distribution curve simulated by a Gamma function, and Est_Normal is an extreme value-cumulative probability distribution curve simulated by a Gaussian function. A probability distribution of the negative samples is obtained from a best-fit curve, and a function with a highest degree of fitting is obtained as the probability distribution model.

As shown in step S18, the processing device 12 calculates a confident interval based on the probability distribution model. In detail, the disclosure provides an error probability value. In an embodiment, a type 1 error probability value is expressed as an a value, and a preset value is 0.01 that represents a probability of 1% that a negative sample (normal sample) is mistaken for a sample with defects. The error probability value is inputted into the probability distribution model to obtain the confident interval. If the error probability value is 0.01, the confident interval is a limit value corresponding to a probability of [0, 0.99], including an upper limit value (a right limit value) and a lower limit value (a left limit value).

Finally, as shown in step S20, the processing device 12 obtains a threshold with meaning of negative sample probability distribution based on the upper limit value of the confident interval. Because a fitting function represents “a probability distribution of the anomaly scores of negative samples”, an extreme value obtained by the confident interval represents “a possible anomaly score of the negative samples within the confident interval”. In an embodiment, if a limit value of the confident interval corresponding to the probability of [0, 0.99] is [3, 57], it represents that 99% of the anomaly scores of negative sample data fall within the interval of 3-57. Therefore, the threshold is set to 57, representing that only 1% of the negative sample data without defects is erroneously determined as a positive sample with defects.

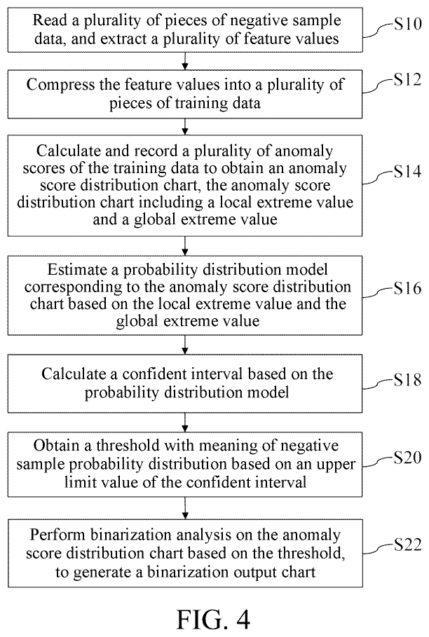

Referring to FIG. 1 and FIG. 4 together, after the processing device 12 obtains the threshold with the meaning of negative sample probability distribution through step S10 to step S20 in sequence, as shown in step S22, the processing device 12 further performs binarization analysis on the anomaly score distribution chart based on the threshold to generate a binarization output chart, thereby determining whether the binarization output chart is negative sample data or positive sample data. In an embodiment, when the error probability value (αvalue) is set to 0.012, the corresponding threshold is 57. A block with an anomaly score greater than 57 on the anomaly score distribution chart is set to represent a number 1 (marked as 1) with defects, and a block with the anomaly score less than 57 on the anomaly score distribution chart is set to represent a number 0 (marked as 0) without defects. Finally, after the binarization output chart is generated, if the binarization output chart does not include the number 1, it represents that the chart is negative sample data without defects. On the contrary, if the binarization output chart includes the number 1, it represents that a defect is predicted on a position of the block, which means that the chart is positive sample data.

Based on the above, the disclosure provides a threshold estimation method and an electronic device. In a training process of an unsupervised defect detection artificial intelligence model, a threshold is effectively estimated through the negative sample data, to propose a consistency standard based on the probability distribution. Therefore, a user does not need to provide a positive sample, collect additional positive samples, or worry that the provided positive sample data is biased data, thereby affecting the defect setting. In addition, the threshold and the probability distribution obtained through a probability distribution model trained with probabilistic anomaly scores of negative samples directly represent results of model prediction. Therefore, users set an error probability value (a value) based on the type 1 error they want to bear, or uses p=0.05 commonly used in statistics as a preset value. Therefore, the disclosure does not need extra computing power and time for estimation of the artificial intelligence model, and the calculation is completed at the same time when the unsupervised model training process is completed.

The foregoing embodiments are merely for describing the technical ideas and characteristics of the disclosure, which are intended to enable a person skilled in the art to understand and implement the content of the disclosure accordingly, and do not constitute a limitation on the patent scope of the disclosure. In other words, equivalent changes or modifications made to the spirit provided in the disclosure still fall within the scope of the patent application of the disclosure.

What is claimed is:

1. A threshold estimation method, comprising:
reading a plurality of pieces of negative sample data, and extracting a plurality of feature values;
compressing the feature values into a plurality of pieces of training data;
calculating and recording a plurality of anomaly scores of the training data to obtain an anomaly score distribution chart, wherein the anomaly score distribution chart comprises a local extreme value and a global extreme value;
estimating a probability distribution model corresponding to the anomaly score distribution chart based on the local extreme value and the global extreme value;
calculating a confident interval based on the probability distribution model; and
obtaining a threshold with meaning of negative sample probability distribution based on an upper limit value of the confident interval.

2. The threshold estimation method according to claim 1, wherein in the step of extracting the feature values, the feature values are extracted from the negative sample data through a deep learning model.

3. The threshold estimation method according to claim 1, wherein the feature values are compressed into the training data in a dimension reduction manner.

4. The threshold estimation method according to claim 1, wherein the anomaly scores of the training data are calculated through a defect detection algorithm.

5. The threshold estimation method according to claim 1, wherein the probability distribution model is a thick tail probability model.

6. The threshold estimation method according to claim 5, wherein the local extreme value is an unbiased estimator of the global extreme value, kernel density estimation (KDE) is performed on distributions of the local extreme value and the global extreme value through Gaussian distribution and Gamma distribution respectively, to perform curve fitting, and a function with a highest degree of fitting is obtained as the probability distribution model.

7. The threshold estimation method according to claim 1, wherein in the step of calculating the confident interval, the method further comprises inputting an error probability value into the probability distribution model to obtain the confident interval.

8. The threshold estimation method according to claim 7, wherein the error probability value is a type 1 error probability value.

9. The threshold estimation method according to claim 1, further comprising: performing binarization analysis on the anomaly score distribution chart based on the threshold, to generate a binarization output chart.

10. An electronic device, comprising:
a storage device, storing a plurality of pieces of negative sample data; and
a processing device, electrically connected to the storage device, wherein the processing device is configured to: read the negative sample data, extract a plurality of feature values, compress the feature values into a plurality of pieces of training data, and calculate and record a plurality of anomaly scores of the training data to obtain an anomaly score distribution chart, the anomaly score distribution chart comprising a local extreme value and a global extreme value, estimate a probability distribution model corresponding to the anomaly score distribution chart based on the local extreme value and the global extreme value, calculate a confident interval based on the probability distribution model, and obtain a threshold with meaning of negative sample probability distribution based on an upper limit value of the confident interval.

11. The electronic device according to claim 10, wherein the processing device is configured to extract the feature values from the negative sample data through a deep learning model.

12. The electronic device according to claim 10, wherein the processing device is configured to compress the feature values into the training data in a dimension reduction manner.

13. The electronic device according to claim 10, wherein the anomaly scores of the training data are calculated through a defect detection algorithm.

14. The electronic device according to claim 10, wherein the probability distribution model is a thick tail probability model.

15. The electronic device according to claim 14, wherein the local extreme value is an unbiased estimator of the global extreme value, KDE is performed on distributions of the local extreme value and the global extreme value through Gaussian distribution and Gamma distribution respectively, to perform curve fitting, and a function with a highest degree of fitting is obtained as the probability distribution model.

16. The electronic device according to claim 10, wherein the processing device is configured to input an error probability value into the probability distribution model to obtain the confident interval.

17. The electronic device according to claim 16, wherein the error probability value is a type 1 error probability value.

18. The electronic device according to claim 10, wherein the processing device is further configured to perform binarization analysis on the anomaly score distribution chart based on the threshold, to generate a binarization output chart.

19. The electronic device according to claim 10, further comprising a graphics processing unit, wherein the graphics processing unit is electrically connected to the processing device, and assists the processing device in performing operation.
